(19) United States
(12) Patent Application Publication
(10) Pub. No.: US 2023/0316202 A1
(43) Pub. Date: Oct. 5, 2023

(54) METHODS AND APPARATUSES FOR AUTOMATICALLY PREDICTING FILL RATES

(71) Applicant: Walmart Apollo, LLC, Bentonville, AR (US)

(72) Inventors: Michael Bartlett Allen, Fayetteville, AR (US); Javier Guzman Uvence, Rogers, AR (US); Nicolas Martin Sica, Bentonville, AR (US); Jorge Hernandez Quan, Bentonville, AR (US)

(21) Appl. No.: 18/025,230

(22) PCT Filed: Oct. 15, 2020
(86) PCT No.: PCT/US2020/055809

§ 371 Date: Mar. 8, 2023

(51) Int. Cl. G06Q 10/0637; G06Q 10/087

(52) U.S. Cl. CPC G06Q 10/06375; G06Q 10/087

(57) ABSTRACT

A computing device is configured to obtain order attribute data characterizing at least one order placed and to obtain rank data characterizing a supply performance versus other supply performances. The computing device can also be configured to obtain recency data characterizing a past supply performance and to determine a probability of an in-full fill rate of the at least one order using a fill rate prediction model. The computing device can also send the probability of the in-full fill rate to a supply partner.

### TECHNICAL FIELD

The disclosure relates generally to automatically predicting fill rates. More particularly, the disclosure relates to automatically predicting whether vendors will be able to fill orders placed by sellers.

### BACKGROUND

Sellers, and in particular large scale retailers, often place many orders with various vendors according to the needs of the sellers. Sellers and vendors often communicate with each other regarding the vendors' ability to satisfy the order of the sellers with products and services. Vendors may be unable to satisfy the needs of the sellers and can either under deliver on the ordered items or order quantities of the sellers. The vendors' inabilities to satisfy the orders of the sellers can be caused by any number of factors. If the seller is unaware that the vendor is unable to deliver the ordered goods or services, the seller may forego sales that the seller could have otherwise made. If the seller is aware that the vendor is unable to deliver the ordered goods or services, the seller can make other plans to obtain the desired goods or services such as ordering from an alternate vendor or making customers or downstream partners aware of such shortfalls.

Sellers and vendors, in some instances, can have complex information technology systems that can ease the communication of orders and supply. Such systems, however, suffer from various drawbacks. Some of these drawbacks include expensive up-front costs and the need for the sellers and vendors to have common platforms, software and/or communication systems. Existing systems can also require active participation by both sellers and vendors to input order and fulfillment information as well as to revise such inputs in light of changes. In addition, the sellers and/or vendors may not be aware of upcoming orders or their own constraints that can cause orders to go unfulfilled. There exists a need, therefore, for improved systems that can accurately and repeatably predict the fill rates of orders placed by sellers. The benefits for such improved systems and methods include reduced costs, increased sales, easier communication in the supply chain as well as the identification of areas for improvements in ordering and supply processes.

### SUMMARY

The embodiments described herein are directed to a fill rate prediction system and related methods. The fill rate prediction system can be implemented using one or more computing devices that can include operative elements that can determine the probability of in-full fill rates of sellers' orders and send such probabilities to a supply partner. The fill rate prediction system can be effectively used to improve the supply chain by identifying orders that will go unfulfilled so that the seller can take remedial actions and the vendor can be aware of trends that may exist in its ability to supply order in-full and on-time.

In accordance with various embodiments, exemplary systems may be implemented in any suitable hardware or hardware and software, such as in any suitable computing device. In some embodiments, a computing device can be configured to obtain order attribute data characterizing at least one order placed and to obtain rank data characterizing a supply performance versus other supply performances. The computing device can also be configured to obtain recency data characterizing a past supply performance and to determine a probability of an in-full fill rate of the at least one order using a fill rate prediction model. The computing device can also send the probability of the in-full fill rate to a supply partner.

In accordance with various embodiments, exemplary systems may be implemented in any suitable hardware or hardware and software, such as in any suitable computing device. For example, in some embodiments, a computing device is configured to obtain order attribute data characterizing at least one order placed by a seller from a vendor and to obtain vendor rank data characterizing a supply performance of the vendor versus other vendors. The computing device can also be configured to obtain vendor recency data characterizing the vendor's past supply performance and to determine a probability of an in-full fill rate of the at least one order using a fill rate prediction model. The computing device can also send the probability of the in-full fill rate to a supply partner.

In one aspect, the order attribute data includes a quantity of items ordered, a date of placement of the at least one order and a lead time.

In another aspect, the vendor rank data includes an overall vendor rank and a distribution center rank.

In another aspect, the vendor recency data includes an average fill rate for a predetermined number of previously placed orders and an overall average fill rate for each item in the at least one order.

In another aspect, the computing device is further configured to determine at least one predicted future order from the seller to the vendor and to determine a probability of an in-full fill rate for the at least one predicted future order using the fill rate prediction model.

In another aspect, the fill rate prediction model is a trained model trained using supervised machine learning.

In another aspect, the sending the probability of the in-full fill rate to the supply partner includes displaying the probability on a fill rate user interface, wherein the supply partner is one of a vendor, a supply analyst and a distribution partner

In some embodiments of the present disclosure a method of predicting the probability of a fill rate is provided. The method can include obtaining order attribute data characterizing at least one order placed by a seller from a vendor and obtaining vendor rank data characterizing a supply performance of the vendor versus other vendors. The method can also include obtaining vendor recency data characterizing the vendor's past supply performance and determining a probability of an in-full fill rate of the at least one order using a fill rate prediction model. The method can also include sending the probability of the in-full fill rate to a supply partner.

In yet other embodiments, a non-transitory computer readable medium has instructions stored thereon, where the instructions, when executed by at least one processor, cause a computing device to perform operations that include obtaining order attribute data characterizing at least one order placed by a seller from a vendor and obtaining vendor rank data characterizing a supply performance of the vendor versus other vendors. The operations can also include obtaining vendor recency data characterizing the vendor's past supply performance and determining a probability of an in-full fill rate of the at least one order using a fill rate prediction model. The operations can also include sending the probability of the in-full fill rate to a supply partner.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a fill rate prediction system in accordance with some embodiments;

FIG. 2 is a block diagram of a fulfillment computing device of the fill rate prediction system of FIG. 1 in accordance with some embodiments;

FIG. 3 is a block diagram illustrating examples of various portions of the fill rate prediction system of FIG. 1 in accordance with some embodiments;

FIG. 4 is a block diagram illustrating examples of various portions of another fill rate prediction system in accordance with some embodiments;

FIG. 5 is a diagram illustrating an example process of automatically predicting fill rates using one of the example fill rate prediction systems in accordance with some embodiments;

FIG. 6 is an illustration showing an example user interface that can be displayed by an example fill rate prediction system in accordance with some embodiments; and

FIG. 7 is a flowchart of an example method of predicting fill rates in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “connected,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Sellers of goods often use multiple vendors to provide goods and services that it may use to manufacture finished goods or to sell in various outlets such as online or physical retail stores. The supply chain of sellers can vary in various industries and can range from simple to complex. In the context of big box retailers that may sell goods from various suppliers in online and physical stores, the sellers must place orders for goods well in advance of the delivery of such items to a customer or to the stocking of goods in a retail store.

In order to prevent situations in which a good may be unavailable for delivery or for sale in a store, the seller can stock increased numbers of goods in a warehouse or at a store. Such increased inventory (or larger buffers in the supply chain) carry an increase in cost for the seller due to requirements of warehouse space and the cost of holding the goods until a customer may purchase the goods. Sellers can also provide increased visibility or increased communications with its vendors and supply chain partners. One type of solution is to provide an integrated information technology system whereby sellers, vendors and other supply chain partners can share information regarding inventory levels, advance shipment notices, anticipated orders, returns, and the like. Such information systems, however, have several disadvantages. The disadvantages include requirements that seller, vendor and/or supply chain partners have to agree on a technological platform and dedicate time and resources to share information. Many smaller vendors that may be part of a supply chain for a large retailer, for example, may be not able or willing to invest in such information technology systems.

Another disadvantage of existing information sharing solutions includes the need of the seller to integrate with many different companies. In the context of a large retailer, the retailer may be sourcing goods from hundreds or thousands of different vendors from across the globe. The requirement to integrate information systems with each vendor can be very difficult, time consuming and costly.

Existing information sharing solutions are also typically focused on sharing and analyzing orders that are known or that have been placed by a seller with a vendor. This focus on existing orders misses the opportunity to predict future orders or predict future shortfalls. As such, the impact of existing information sharing systems can be less than can be achieved using the systems and methods of the present disclosure.

In the present disclosure, the examples are described in the context of a large retailer that purchases goods from vendors and sells such goods to customers through online or physical stores. It should be appreciated, however, that the systems and methods of the present disclosure are not limited to a retail environment. The systems and methods of the present disclosure can be applied in various other supply chains such as in manufacturing, logistics and service environments. While the terms seller and vendor may be used in the present disclosure, the seller can include any party, organization or entity that may order goods or services from a provider. In other contexts, the seller may not re-sell the goods or services and instead may be an end user of the goods or an interim manufacturer, for example. Similarly, the vendor may not be a conventional vendor but may be any provider that may make goods or services available to another. In other contexts, the vendor may deliver, distribute goods or services or otherwise provide the goods or services in response to an order.

The methods and systems of the present disclosure can automatically determine the supply fill rates of vendors. These methods and systems can accurately predict if orders made by sellers to vendors will be delivered. The systems and methods can easily integrate the large quantity of vendors that may be present in a large retailer's supply chain and can easily integrate or disassociate vendors that may join the supply chain or be removed from the supply chain. The systems and methods of the present disclosure can make use of machine learning to accurately predict the fill rate of vendors.

In one example, the systems can use historical data that has been previously collected by the seller or by another third party to train a machine learning model to accurately predict fill rates of vendors. The seller then can use data from existing or placed orders to predict the likelihood that such orders will be filled by its vendors. Since such an example system uses data that is owned or controlled by the seller and does not require input from the vendors, the systems and methods of the present disclosure have the benefit of not requiring the technological integration of information systems with all of its vendors. Unlike existing systems, the systems and methods of the present disclosure can predict fill rates and can make this information available to its supply chain partners. Furthermore, the trained fill rate prediction models of the present disclosure can identify patterns across vendors that make the integration of new vendors simple and easy while still providing accurate predictions of fill rates. Still further, the systems and methods of the present disclosure can be used not only to predict fill rates for current orders but also to simulate probable orders that may be placed in the future and provide fill rate predictions for the probable orders as well. This functionality extends the time horizon for which the prediction system can predict future fill rates.

By employing the advantages of the systems and methods of the present disclosure, sellers can improve the operation of its supply chain which can in turn, improve the financial performance of a seller. The accurate predictions allows the seller to take remedial actions in view of anticipated shortfalls of goods. The predictions can also be used by vendors in the supply chain to address volatility, bottlenecks, process problems or other issues. The seller and/or the vendor can also reduce buffers that may in place in the supply chain because of the increased visibility of probable supply issues. These actions can improve sales, reduce costs and improve customer satisfaction.

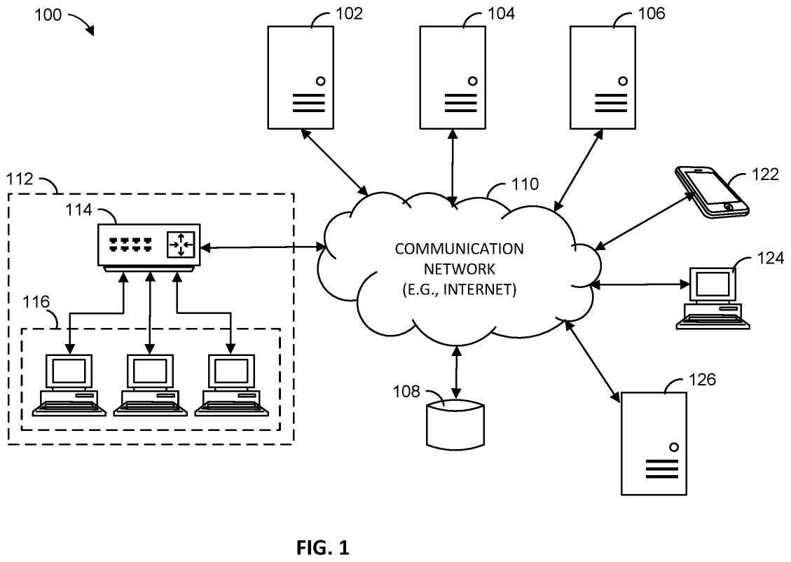

Turning to the drawings, FIG. 1 illustrates a block diagram of a fill rate prediction system 100 that includes a prediction computing device 102 (e.g., a server, such as an application server), a central ordering computing device 112, an information source 104 (e.g., a web server), a distribution center computing device 106, a database 108, a supply partner mobile computing device 122, a supply partner workstation 124, and a supply partner computing device 126 operatively coupled over network 110. Prediction computing device 102, central ordering computing device 112, first information source 104 (e.g., a web server), distribution center computing device 106, database 108, supply partner mobile computing device 122, supply partner workstation 124, and supply partner computing device 126 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 110.

In some examples, prediction computing device 102 can be a computer, a workstation, a laptop, a server such as a cloud-based server, or any other suitable device. In some examples the supply partner mobile computing device 122 can be a cellular phone, a smart phone, a tablet, a personal assistant device, a voice assistant device, a digital assistant, a laptop, a computer, or any other suitable device. In some examples, prediction computing device 102 is operated by seller or retailer, and the supply partner computing devices 122, 124, 126 can be operated by a vendor of the seller.

The central ordering computing device 112 can include one or more workstations 116 that can be coupled to a server, communication network or router 114. The central ordering computing device 112 can, for example, be located at a headquarters, purchasing department, store, warehouse or other seller location. The central ordering computing device 112 can allow the seller to prepare and submit orders to the vendors that may be present in the supply chain of the seller. The central ordering computing device 112 can allow the seller to send information to the vendors with information regarding the details of an order. Such details can include, for example, the identification of items in the order, a quantity of items ordered, a date of placement and a lead time for the order. The central ordering computing device 112 can allow the seller to send the order information via an ordering system, via email, via an order form or any other suitable communication. The central ordering computing device 112 can also be operable to store the order information in the central ordering computing device 112, in database 108 or in any other suitable data storage device that can be accessed by the central ordering computing device 112.

Prediction computing device 102 can also be operable to communicate with database 108 over the communication network 110. The database 108 can be a remote storage device, such as a cloud-based server, a memory device on another application server, a networked computer, or any other suitable remote storage. Although shown remote to prediction computing device 102, in some examples, database 108 can be a local storage device, such as a hard drive, a non-volatile memory, or a USB stick. Prediction computing device 102 can also be operable to communicate with information source 104 in order to acquire, obtain or otherwise collect information that can be used during the process of predicting fill rates. While only one information source 104 is shown, prediction computing device 102 can be operable to communicate with multiple information sources 104 or other computing devices, servers and supply chain information systems.

Communication network 110 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 110 can provide access to, for example, the Internet.

The vendor computing devices 122, 124, 126 may communicate with the prediction computing device 102 and/or the central ordering computing device 112 over communication network 110. For example, the prediction computing device 102 and/or the central ordering computing device 112 may host one or more web sites or suitable web-based application or other software interfaces. Each of the vendor computing devices 122, 124, 126 may be operable to view, access and interact with the prediction computing device 102 and/or the central ordering computing device 112 or other supply partner interfaces hosted, controlled or otherwise operated by the seller. In some examples, the prediction computing device 102 and/or the central ordering computing device 112 can allow a vendor via a supply partner interface to view, interact, download or otherwise access the predicted fill rates or other supply chain information.

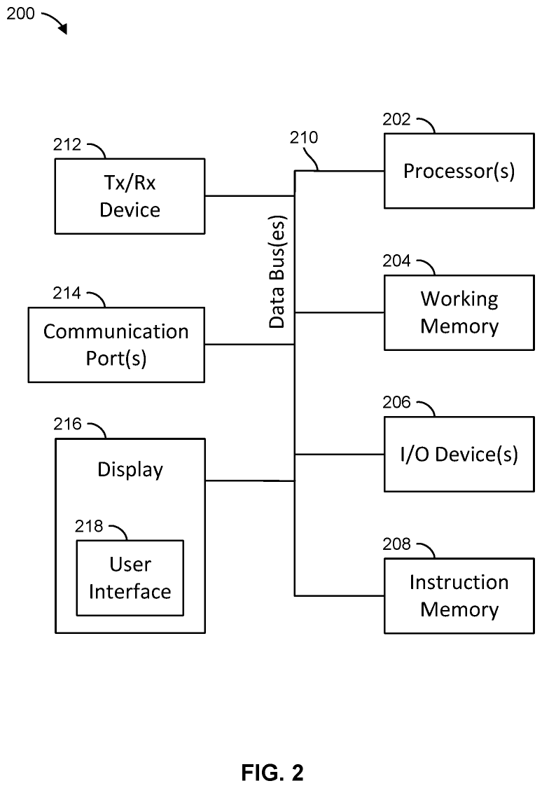

FIG. 2 illustrates an example computing device 200. The prediction computing device 102, the central ordering computing device 112, the information source 104, the distribution center computing device 106, the database 108, the supply partner mobile computing device 122, the supply partner workstation 124, and/or the supply partner computing device 126 may include the features shown in FIG. 2. For the sake of brevity, FIG. 2 is described relative to the prediction computing device 102. It should be appreciated, however, that the elements described can be included, as applicable, in the central ordering computing device 112, the information source 104, the distribution center computing device 106, the database 108, the supply partner mobile computing device 122, the supply partner workstation 124, and/or the supply partner computing device 126.

As shown, the prediction computing device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of the prediction computing device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as historical markdown data, optimized price markdowns, experimental price markdowns, final recommended price markdown data, customer purchasing data, historical savings data and other types of data described herein.

Display 216 can display a user interface 218. User interfaces 218 can enable user interaction with the prediction computing device 102 and/or with various data, predictions, graphs or other analysis that may be performed by the prediction computing device 102 or elements thereof. For example, user interface 218 can be a user interface that allows a supply partner to view, interact, communicate, control and/or modify different features, data, analyses or parameters of the prediction computing device 102. The user interface 218 can, for example, display predictions, probabilities or other analyses regarding fill rates of various vendors. The user interface 218 can include text, tables, graphs, images, or other types of displays to allow a supply partner to view the outputs of the prediction computing device 102. In some examples, a user can interact with user interface 218 by engaging input-output devices 206. In some examples, display 216 can be a touchscreen, where user interface 218 is displayed on the touchscreen. In other examples, the user interface 218 is configured to be displayed on a mobile computing device such as a smart phone.

Transceiver 212 allows for communication with a network, such as the communication network 110 of FIG. 1. For example, if communication network 110 of FIG. 1 is a cellular network, transceiver 212 is configured to allow communications with the cellular network. In some examples, transceiver 212 is selected based on the type of communication network 110 that prediction computing device 102 will be operating in. Processor(s) 202 is operable to receive data from, or send data to, a network, such as communication network 110 of FIG. 1, via transceiver 212.

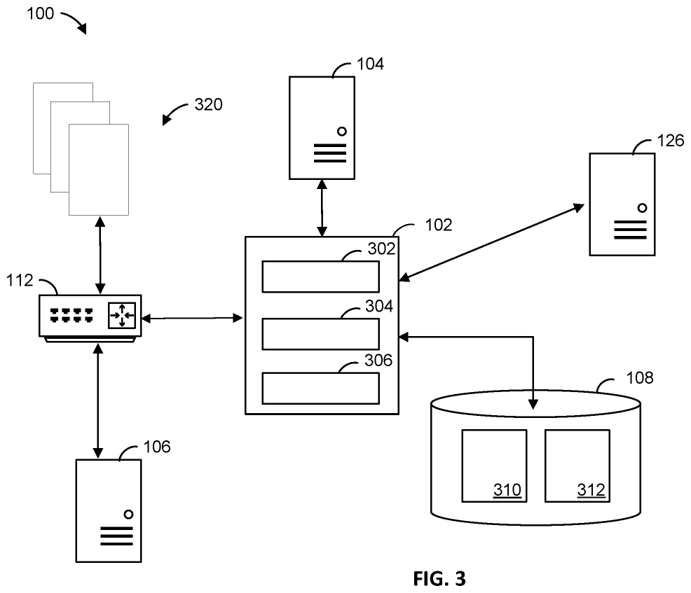

Turning now to FIG. 3, further aspects of the fill rate prediction system 100 are shown. The fill rate prediction system 100, in this example, is shown with the various elements operatively connected together. The connections can be facilitated by use of the network 110 (FIG. 1) or by other wireless or wired connections. In this example, the prediction computing device 102 is connected to the central ordering computing device 112, to the information source 104, to the supply partner computing device 126 and the database 108.

The prediction computing device 102 can operate to obtain various types and quantities of data from one of more of these computing devices in order to determine a probability that a vendor will be able to fill an order for goods that is placed by the seller. The central ordering computing device 112 can allow the seller to place orders for various goods with vendors 320. The orders can be sent via any suitable method including via paper, mail, email, electronic data transfer, inventory management system or other electronic data communication system. After receipt of the orders from the seller, the vendors can deliver the ordered goods to seller. The ordered goods, in one example, can be delivered to a distribution center of the seller. In other examples, the orders can be delivered to a warehouse, directly to the seller, to a retail location, factory or the like. When the ordered goods are received by the seller, the seller can record various types of information regarding the ordered goods such as identifying information, vendor identifying information, quantity received, quality of the items received and any other information that may be desired. The information about the ordered goods can be recorded and stored in a distribution center computing device 106 and can be subsequently sent and stored in information source 104 and/or in database 108.

The prediction computing device 102 can operate to retrieve the various types of information that have been recorded and stored regarding the orders of the seller and the items received from the vendor. The prediction computing device 102 can include, for example, a data retrieval engine 302. The data retrieval engine 302 can include any suitable hardware and/or software suitable to retrieve data from the central ordering computing device 112, the distribution center computing device 106, the information source 104 and/or the database 108. In some examples, the data retrieval engine 302 can include application protocol interfaces (APIs) or the like that can access data and retrieve data as necessary to perform the operations to predict vendor fill rates and/or to train the prediction models as will be further explained below.

The order information can include various types of information as previously described. In one example, the order information can include order attribute data 310. The order attribute data 310 can be stored in database 108 or in any suitable memory device. The order attribute data 310 can include a quantity of items ordered, a date of placement of the order and a lead time of the order. The order attribute data 310 can also include other types or other pieces of information that may be associated with or sent to a vendor in an order for goods.

The prediction computing device 102 can also include a fill rate engine 304. The fill rate engine 304 can operate to determine a likelihood that an order will be filled by a vendor. Such operations can be performed for orders that have been placed by the seller to a vendor. The fill rate engine 304 can also operate to predict orders that will be made by the seller to a vendor in the future. In this manner, the seller and the vendor can use such predictions to take actions to improve on the timely delivery of the goods that otherwise may not occur. The fill rate engine 304, in one example, can be a trained machine learning model. The model can be trained using historical data regarding past orders and the fill rates of the vendors for such past orders. After training, the fill rate engine 304 can then be implemented to predict fill rates of current orders and to predict future fill rates of predicted future orders.

In one example, the fill rate engine 304 is a trained machine learning model implemented using gradient boosted decision trees. In other examples, the model can be implemented using a gradient boosting machine, statistical methodologies, tree-based models and the like. The fill rate engine 304 can be trained and implemented using any suitable open source or proprietary software or other libraries. The fill rate engine 304 can be trained using a structured or tabular dataset that include historical data such as order attribute data, vendor data and vendor recency data. In other examples, other data can be used. The order attribute data, the vendor data and the vendor recency data can be structured to include historical or previous fill rate data. The fill rate engine 304 can be trained using data such that the trained machine learning model can accurately predict the likelihood that an order will be delivered to the seller in full. The structured and tabular data can include the order and vendor data (as further described below) and can be a trained model using supervised machine learning in that the structured data is associated with a binary indication of whether the order is delivered in full or is not delivered in full. In one industry, historical data and experience tends to show that the vast majority (>98%) of orders are either delivered in full or not delivered at all. By using this observation, the learning of the model can be simplified and the results are improved. Thus, the fill rate engine 304 (after training) indicates to the users and other supply partners the likelihood that the order will have a 100% fill rate. In other industries, markets or supply chains, there may be other observations regarding the delivery of orders. Such differences may exist due to the nature of the ordered goods or services, for example. In such alternate environments, the fill rate engine 304 can be trained and implemented to indicate other predictions regarding fill rates such as a likelihood that 80% of the order will be filled or a likelihood that 50% of the order will be filled. In still other examples, the fill rate engine 304 can be trained and implemented to determine other aspects or probabilities of fill rates.

As discussed above, the fill rate engine 304 can be trained and implemented to use order attribute data, vendor rank data and/or vendor recency data. In one example, the order attribute data can include data that characterizes orders placed by the seller to a vendor. The order attribute data can include, for example, a quantity of items ordered, a date of placement of the order, a lead time for the order, and an identification of the ordered goods. In other examples, the order attribute data can include other pieces of information that may characterize the orders placed by the seller. The order attribute data can be stored in any suitable data storage location such as in database 108.

The data used to train and implement the fill rate engine 304 can also include vendor data 312 that can include vendor rank data and vendor recency data. The vendor rank data can include information that characterizes a vendor's performance versus other vendors used by the seller. Vendor rank data can include, for example, an overall vendor rank (e.g. a rank of the vendor versus all other vendors used by the seller), and a distribution center rank (e.g., a rank of the vendor versus other vendors that deliver ordered goods to a particular distribution center). The rankings can be based on any suitable metric such as the number of orders with 100% fill rates, the number of items delivered, the value of items delivered or the like. The vendor rank data may not be static. The vendor rank data can change over time as a result of the performance of various vendors may change over time. This dynamic aspect of the vendor rank data assists the fill rate engine 304 and/or any models included therein to adapt to changes and new patterns. The fill rate engine 304 may need to be retained periodically to ensure the best prediction accuracy. The vendor rank data can be retrieved from any suitable data storage device such as the database 108 and/or the distribution center computing device 106.

The data used to train and implement the fill rate engine 304 can also include vendor recency data. The vendor recency data can include information that characterizes the vendor's past supply performance. The past supply performance can include any suitable information associated with the vendor's deliveries to the supplier and/or to a distribution center of the supplier in response to receiving previous orders from the seller. The vendor recency data can include, for example, an average fill rate of previous orders, fill rates of previously ordered items, fill rates for orders that are delivered to a particular distribution center, fill rates for items delivered to a particular distribution center and the like. In still other examples, the vendor recency data can include data of an item fill rate by the vendor of the last five orders, a fill rate by the vendor to a distribution center of the last five orders, an item fill rate by the vendor for the last order, an item fill rate by the vendor to a distribution center for the last order, an average quantity of items ordered for the last five orders, and a total cost for the previous orders. In other examples, the vendor recency data can include other information and can use different periods or different look-back period for the recency data. For example, some of the information described above includes averages or fill rates for previous orders. Such averages or previous orders can use any suitable look-back period such as the previous 5 orders, the previous 10 orders, the previous 15 orders or all available orders. The vendor recency data can be retrieved from any suitable storage device such as the database 108 and/or the distribution center computing device 106.

The fill rate engine 304 can also be trained and/or implemented using other information from other sources. The fill rate engine 304 can, for example, use external data. External data can be any data that includes information that can impact a vendor's ability to fill orders but may be data available for external or extrinsic environmental factors. Such external data can include, for example, weather data, seasonal pattern data, current event data, economic data and the like. The external data can be retrieved from any suitable source or storage device such as from information source 104 and/or database 108.

As also shown in FIG. 3, the prediction computing device 102 can include a validation engine 306. The validation engine 306 can operate to evaluate and/or assess the performance of the fill rate engine 304 in predicting a fill rate of vendors. The validation engine 306 can compare the predicted fill rates against actual fill rates. The validation engine 306 can use any suitable method for conducting such assessments. In one example, the validation engine 306 can sample past orders and compare the predictions for the fill rates of such orders as determined by the fill rate engine 304 against the actual fill rates of the orders. The actual fill rates can be retrieved, for example, from the distribution center computing device 106 and/or from the central ordering computing device 112 and/or from the supply partner computing devices 122, 124, 126. The results of the validation engine 306 can be communicated to supply partners and to various departments of the seller. In this manner, improvements, changes, re-training or other further actions can be determined.

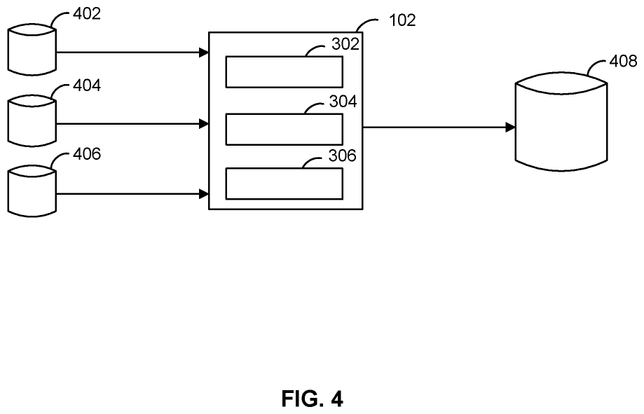

Turning now to FIG. 4, an example implementation of the prediction computing device 102 is shown. In this example, the prediction computing device 102 is operable to obtain order attributes 402 (e.g., order attribute data 310), to obtain vendor and distribution center attributes 404 (e.g., vendor rank data), and to obtain recency attributes 406 (e.g., vendor recency data). This data can be retrieved, for example, by the data retrieval engine 302. The data can be input into the fill rate engine 304 to determine a prediction for the fill rate of the orders of the seller. For example, the fill rate engine 304 can determine probabilities of in-full delivery of orders 408. The probabilities of in-full delivery can be determined at the item level (i.e., for each individual item included in an order) and at the order level (i.e., for all items included in a particular order).

The fill rate engine 304 can be trained using any suitable data set that the model can use to determine patterns and relationships between a vendor and the vendor's ability to provide in-full delivery of the items in the order. In one example, the data used to train the model can include the following input data fields.
Order Lead Time
Flag indicating System or Manual Order
Regular Item Cost
Item Cost on this order (may have a special discount)
Item Order Quantity
Day of Week of Order
Month of Order
Month Period (3 periods—Day 1-7, Day 8-25, Day 25+)
Vendor Location (represented as a ‘sequence’ flag)
Delivery Location (which Distribution Center “DC”)
Total Order Quantity (including all items on the order)
Total Order Cost (including all items on the order)
Item Fill Rate of Last Order (delivered anywhere)
Item Fill Rate of Last Order at this DC
Total Vendor Fill Rate of Last Order (delivered anywhere)
Total Vendor Fill Rate of Last Order at this DC
Avg Item Fill Rate of Last 5 Orders (anywhere)
Avg Item Fill Rate of Last 5 Orders at this DC
Avg Vendor Fill Rate of Last 5 Orders (anywhere)
Avg Vendor Fill Rate of Last 5 Orders at this DC
Avg Item Fill Rate of Last 10 Orders (anywhere)
Avg Item Fill Rate of Last 10 Orders at this DC
Avg Vendor Fill Rate of Last 10 Orders (anywhere)
Avg Vendor Fill Rate of Last 10 Orders at this DC

In addition to the data fields shown above, the actual fill rate for the order can be included. In one example data set, the data set includes the above information for a period of two years. In other examples, other quantities of data can be used.

After the fill rate engine 304 is trained, the trained model can be implemented. The same input fields (shown above) can be input into the fill rate engine 304 and the trained model can output various data fields. In one example, the output data fields can include the following.
Purchase Order (“PO”) Number (if a live order, otherwise blank)
Item Number (each item can be identified using an item number)
Item Order Quantity
Order Date
Vendor Number
Distribution Center
Fill Rate Prediction Value

As discussed above, the Fill Rate Prediction Value can be binary (i.e., either a 1 or a 0). A value of 1 indicates that the item will be delivered or a 0 that indicates that the item will not be delivered. In other examples, the Fill Rate Prediction Value can be a probability that the item will be delivered. In such examples, the probability can be rounded to provide a binary result. For example, if the returned probability indicates a 75% likelihood that an item will be delivered, the Fill Rate Prediction Value can be rounded up to 1. In a circumstance that returns a probability of an item to be delivered of 12%, this can be rounded down to 0.

It has been determined that this process of using a binary return of the Fill Rate Prediction Value not only closely follows actual delivery patterns but such a simplification of the model can improve accuracy and improve performance in the supply chain. This may be the case because it is easier for trends and/or areas for improvement to be identified when the result is either an in-full delivery or no delivery. This binary approach can highlight the problems in the supply chain.

In one preferred example, the Fill Rate Prediction Values can be determined at the lowest level of granularity possible. As such, the Fill Rate Prediction Values can be determined for individual items for individual purchase orders. In other examples, the Fill Rate Prediction Values can be determined at higher levels of aggregations such as for total purchase orders, total vendors, total distribution centers, for particular periods of time or the like.

The output of the trained model can also include predictions for future orders. These future orders also include Fill Rate Prediction Values. In this manner, the prediction computing device 102 can determine predicted fill rates into the future to attempt to identify issues in the supply chain even before orders have been issued by the seller to the vendor. The prediction computing device 102 can identify patterns in the orders issued by the seller to various vendors based on the historical data used during the training of the fill rate engine 304.

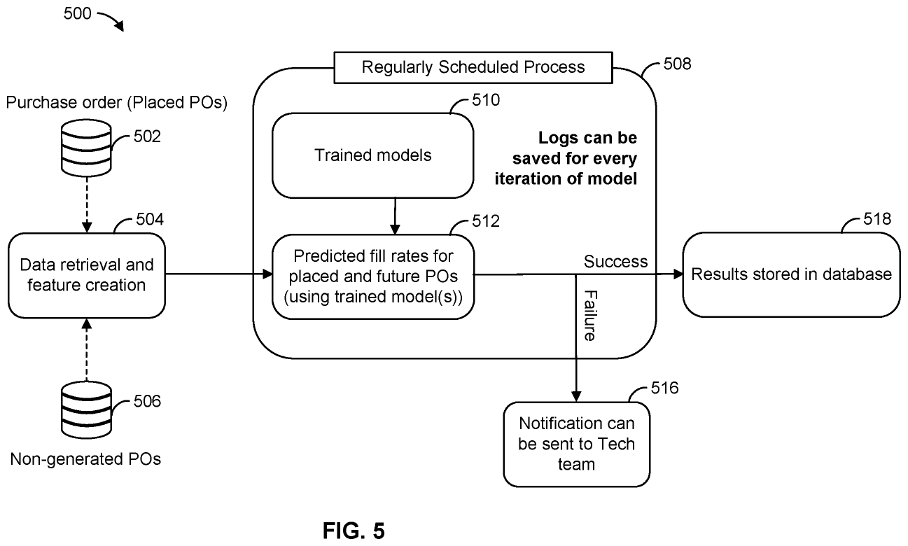

Turning now to FIG. 5, an example process 500 for the determination of fill rates of orders is shown. As shown, the process can be conducted on a periodic or regular basis. As shown, the trained models 510 that can be used for the fill rate engines 304 can be trained and implemented for different departments and/or different markets of the seller. In addition, the fill rate engine 304 can include one or more trained models for each merchandise department or category of goods of the seller. Such an implementation can be advantageous in the context of large retailers and/or sellers with large volumes of available data. The implementation of multiple models can be implemented more efficiently. In addition and as can be appreciated, there may be different trends and/or patterns for different segments or different geographic markets of a particular seller. For example, trained models 510 can be trained and implemented for different categories of goods such as for perishable grocery items, durable goods, appliances, electronics, clothes, and the like. Trained models 510 can also be trained and implemented for different countries, regions, states or the like. Still further, trained models 510 can also be trained and implements for different vendors, suppliers, manufacturers, specialized stores or retailers and for different delivery channels (i.e., home delivery, store delivery, etc.).

The example process 500 can include data retrieval and feature creation 504. At 504, the data used by the trained models 510 can be obtained or retrieved. Such data can be obtained from purchase orders 502, non-generated purchase orders 506. Data can also be retrieved other data sources as well. The data is retrieved and structured as previously described at data retrieval and feature creation 504. This data can flow to the prediction computing device 508. The trained models 510 can determine predicted fill rates for placed orders and for future orders at 512. If the predicted fill rates are determined without errors, the results are stored in a database or other storage device 518. In circumstances in which an error occurs during the determination of the predicted fill rates 512, a notification (e.g., an email, test message or other communication can be sent to the Tech Team (e.g., information technology services department). Such Tech Team can be internal to the seller or can be a third party used by the seller to implement the prediction computing device 508.

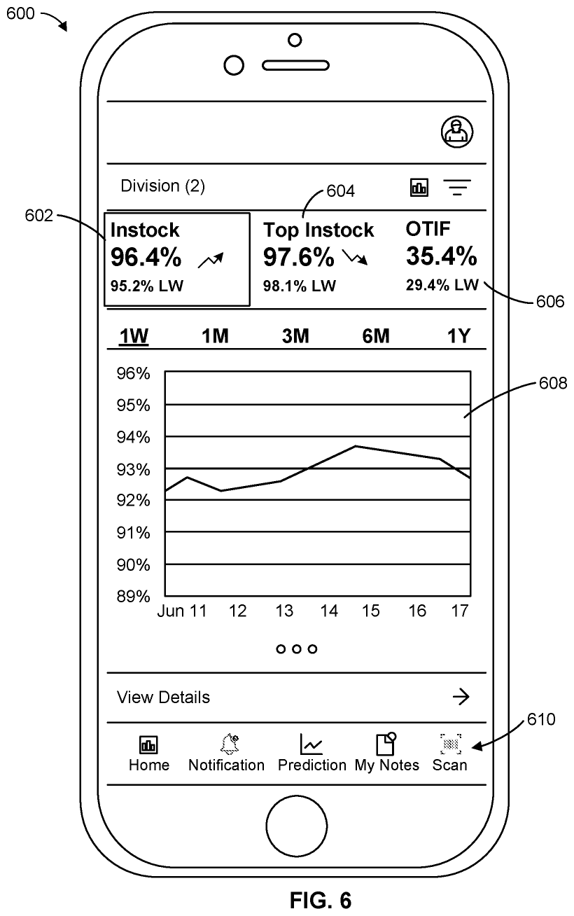

As discussed above, the results of the prediction computing device 102 can be communicated to supply partners such as to vendors, logistics services, retailers, distribution centers, purchasing departments, and the like. The communication provides added visibility to issues that may arise in a supply chain. With the added visibility, alternative sources of goods, shortages and other problems or solutions can be identified in advance and mitigation actions can be taken. In one example (as shown in FIG. 6), the results of the prediction computing device 102 and the predictions of fill rates of orders can be communicated to supply partners using a mobile application with a graphical user interface 600. In other examples, the information can be communicated using a web page, email, text message or other suitable communication.

In the example graphical user interface 600, the information obtained by and determined by the prediction computing device 102 can be displayed using one or more indicators. In this example, the indicators include an Instock indicator 602, a Top Instock indicator 604 and an On-Time In-Full (OTIF) indicator 606. The graphical user interface 600 can also include performance graph 608 that can indicate a fill rate performance as function of time. The periods of time over which a fill rate performance is displayed can be adjusted. In addition, the graphical user interface 600 can include a function bar 610 that can enable a supply partner to access further information and to access additional functionality. The graphical user interface 600 can show historic and predicted results that supply partners can use to take actions. Historical actual fill rate, and predicted future fill rate, can be available for viewing at various levels in the supply chain (total corporate level, vendor level, item level, etc.). The graphical user interface 600 and/or the application that implements the graphical user interface 600 can send/provide alerts for specific predicted problems. The Instock indicators described above and shown in FIG. 6 can identify areas of lost sales, and taken in conjunction with predictions of upcoming poor fill rates, lead to more precise actions that should be taken to avoid continued impact or interruptions in the supply of ordered items.

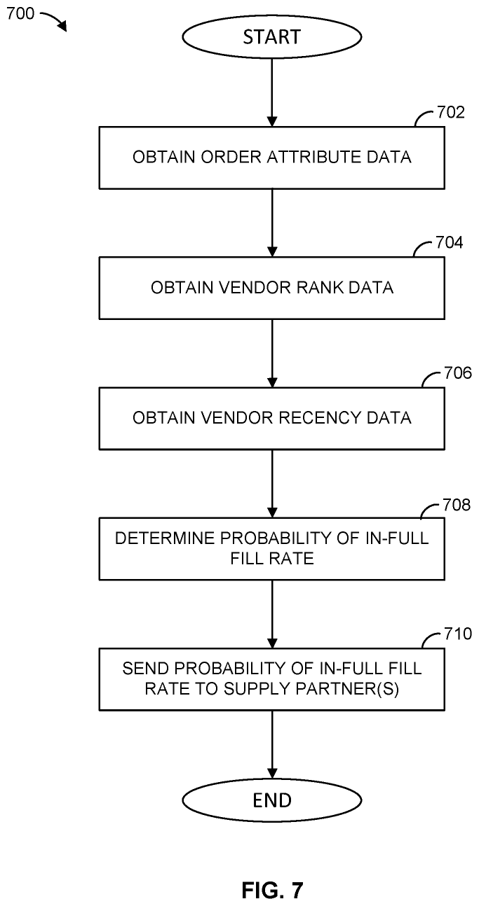

Turning now to FIG. 7, an example method 700 of determining fill rates is shown. While the method can be performed by different systems and computing devices, the method hereinafter is described with respect to the fill rate prediction system 100 that includes the prediction computing device 102 previously described. At step 702, the prediction computing device 102 can obtain order attribute data. The order attribute data can characterize attributes of orders placed by the seller from the vendor. The order attribute data can be obtained, for example, by the data retrieval engine 302. The data retrieval engine 302 can obtain the order attribute data from the database 108, from the distribution center computing device 106, from the central ordering computing device 112 or from another data storage device.

At step 704, the prediction computing device 102 can obtain vendor rank data. The vendor rank data can characterize the supply performance of the vendor as compared to other vendors of the seller. The vendor rank data can be obtained by the data retrieval engine 302. The data retrieval engine 302 can obtain the vendor rank data from the database 108, from the distribution center computing device 106, from the central ordering computing device 112 or from another data storage device.

At step 706, the prediction computing device 102 can obtain vendor recency data. The vendor recency data can characterize a vendor's past supply performance. The vendor recency data can be obtained by the data retrieval engine 302. The data retrieval engine 302 can obtain the vendor recency data from the database 108, from the distribution center computing device 106, from the central ordering computing device 112 or from another data storage device.

At step 708, the prediction computing device 102 can determine a probability of an in-full fill rate. The prediction computing device 102 can determine the probability of an in-full fill rate by using a fill rate prediction model such as the fill rate engine 304 previously described. The fill rate engine 304 can be a trained machine learning model that has been trained using the data sets previously described. The trained machine learning model can use the order attribute data obtained at step 702, the vendor rank data obtained at step 704 and the vendor recency data obtained at step 706 to determine the probability of the in-full fill rate. The probability of the in-full fill rate can be rounded or characterized as a binary result in which either an indication of an in-full delivery is indicated or no delivery is indicated. In other examples, the prediction computing device 102 can determine other probabilities of an in-full fill rate.

At step 710, the prediction computing device 102 can send the probability of an in-full fill rate to supply partners. While any suitable communication or notification can be used, the prediction computing device 102 can provide the probability of the in-full fill rate to the supply partners using a web-based or mobile application. The information can be displayed on a supply partner's computing device via the graphical user interface 600.

While not shown in FIG. 7, the prediction computing device 102 can also determine a performance of the prediction computing device 102 and/or the fill rate engine 304. The performance can be determined by comparing the actual fill rates with the predicted fill rates. In one example, the prediction computing device 102 was trained using one year of historical order and vendor information. The trained model was then implemented and observed for a three month period. During the three month period, the prediction computing device 102 exhibited 84% accuracy at the distribution center level when the predicted fill rates were compared to the actual fill rates. The prediction computing device 102 performed even better when the overall fill rates were compared to the predicted overall fill rates (regardless of distribution center). The predicted overall fill rates exhibited 90% accuracy when compared to the actual overall fill rates.

When implemented, the fill rate prediction system 100 can accurately predict the probability of fill rates in a supply chain. By making these predictions available to supply partners, the vendors, sellers and other supply chain participants can take actions to intercede and proactively address issues that identified. The result can improve operating performances of the sellers and the vendors. The improvements in operating performance can include increased revenues, lower costs and improved customer satisfaction, among others.

Although the methods described above are with reference to the illustrated flowcharts, it will be appreciated that many other ways of performing the acts associated with the methods can be used. For example, the order of some operations may be changed, and some of the operations described may be optional. Furthermore, the methods are not limited to typical seller-vendor relationships. The method can be used in other environments in which one entity places orders and another entity provides goods or services in the order. As such, while the term seller is used to describe the methods and apparatuses above, the party placing the order (e.g., the seller) can be an end user, a manufacturer, a distributor, or other entity. In addition, the vendor can be other types of providers such as manufacturers, couriers, distributors, suppliers, service providers and the like.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain order attribute data characterizing at least one order;
obtain rank data characterizing a supply performance versus other supply performances;
obtain recency data characterizing a past supply performance;
determine a probability of an in-full fill rate of the at least one order using a fill rate prediction model; and
send the probability of the in-full fill rate to a supply partner.

2. The system of claim 1, wherein the order attribute data comprises quantity of items ordered, date of placement of the at least one order and lead time.

3. The system of claim 1, wherein the rank data comprises an overall rank and a distribution center rank.

4. The system of claim 1, wherein the recency data comprises an average fill rate for a predetermined number of previously placed orders and an overall average fill rate for each item in the at least one order.

5. The system of claim 1, wherein the computing device is further configured to:
determine at least one predicted future order; and
determine a probability of an in-full fill rate for the at least one predicted future order using the fill rate prediction model.

6. The system of claim 1, wherein the fill rate prediction model is a trained model trained using supervised machine learning.

7. The system of claim 1, wherein the sending the probability of the in-full fill rate to the supply partner comprises displaying the probability on a fill rate user interface, wherein the supply partner is one of a vendor, a supply analyst and a distribution partner.

8. A method comprising:
obtaining order attribute data characterizing at least one order placed;
obtaining rank data characterizing a supply performance versus other supply performances;
obtaining recency data characterizing a past supply performance;
determining a probability of an in-full fill rate of the at least one order using a fill rate prediction model; and
sending the probability of the in-full fill rate to a supply partner.

9. The method of claim 8, The system of claim 1, wherein the order attribute data comprises quantity of items ordered, date of placement of the at least one order and lead time.

10. The method of claim 8, wherein the rank data comprises an overall rank and a distribution center rank.

11. The method of claim 8, wherein the recency data comprises an average fill rate for a predetermined number of previously placed orders and an overall average fill rate for each item in the at least one order.

12. The method of claim 8, further comprising:
determining at least one predicted future order; and
determining a probability of an in-full fill rate for the at least one predicted future order using the fill rate prediction model.

13. The method of claim 8, wherein the fill rate prediction model is a trained model trained using supervised machine learning.

14. The method of claim 8, wherein the sending the probability of the in-full fill rate to the supply partner comprises displaying the probability on a fill rate user interface, wherein the supply partner is one of a vendor, a supply analyst and a distribution partner.

15. A non-transitory computer readable medium having instructions stored thereon, wherein the instructions, when executed by at least one processor, cause a device to perform operations comprising:
obtaining order attribute data characterizing at least one order;
obtaining rank data characterizing a supply performance versus other supply performances;
obtaining recency data characterizing a past supply performance;
determining a probability of an in-full fill rate of the at least one order using a fill rate prediction model; and
sending the probability of the in-full fill rate to a supply partner.

16. The non-transitory computer readable medium of claim 15, wherein the rank data comprises an overall rank and a distribution center rank.

17. The non-transitory computer readable medium of claim 15, wherein the recency data comprises an average fill rate for a predetermined number of previously placed orders and an overall average fill rate for each item in the at least one order.

18. The non-transitory computer readable medium of claim 15, wherein the instructions, when executed by at least one processor, cause a device to perform operations further comprising:
determining at least one predicted future order; and
determining a probability of an in-full fill rate for the at least one predicted future order using the fill rate prediction model.

19. The non-transitory computer readable medium of claim 15, wherein the fill rate prediction model is a trained model trained using supervised machine learning.

20. The non-transitory computer readable medium of claim 15, wherein the sending the probability of the in-full fill rate to the supply partner comprises displaying the probability on a fill rate user interface, wherein the supply partner is one of a vendor, a supply analyst and a distribution partner.
